(19) United States
(12) Patent Application Publication
(10) Pub. No.: US 2014/0231669 A1
(43) Pub. Date: Aug. 21, 2014

(54) MICROWAVE ION SOURCE AND METHOD FOR STARTING SAME

(71) Applicant: SUMITOMO HEAVY INDUSTRIES, LTD., Tokyo (JP)

(72) Inventors: Nobuaki Takahashi, Kanagawa (JP); Hirohiko Murata, Kanagawa (JP)

(73) Assignee: SUMITOMO HEAVY INDUSTRIES, LTD., Tokyo (JP)

(21) Appl. No.: 14/183,030

(22) Filed: Feb. 18, 2014

(30) Foreign Application Priority Data
Feb. 18, 2013 (JP) 2013-028722

(51) Int. Cl. H01J 27/16

(52) U.S. Cl. CPC H01J 27/16
USPC 250/424; 250/423 R

(57) ABSTRACT

A microwave ion source includes a plasma chamber, a magnetic field generator that generates a magnetic field in the plasma chamber, and a control unit that controls the magnetic field generator to apply an initial magnetic field for plasma ignition to the plasma chamber and change the initial magnetic field to a normal magnetic field after the plasma ignition. The plasma chamber may have a vacuum window that receives a microwave, and an ion extraction opening. The initial magnetic field may have a flat magnetic field distribution from the vacuum window to the ion extraction opening.

### INCORPORATION BY REFERENCE

Priority is claimed to Japanese Patent Application No. 2013-028722, filed Feb. 18, 2013, the entire content of each of which is incorporated herein by reference.

### BACKGROUND

1. Technical Field

The present invention relates to a microwave ion source and a microwave ion source starting method.

2. Description of the Related Art

In the related art, an ion source that uses microwaves to generate plasma is known. The microwaves are introduced into a vacuum plasma chamber. Source gas that is supplied to the plasma chamber is excited by the microwaves and the plasma is generated. Ions are extracted from the plasma. In this manner, the ions that are extracted from the ion source are used in ion implantation processing or the like.

### SUMMARY

According to an embodiment of the present invention, there is provided a microwave ion source including a plasma chamber, a magnetic field generator that generates a magnetic field in the plasma chamber, and a control unit that controls the magnetic field generator to apply an initial magnetic field for plasma ignition to the plasma chamber and change the initial magnetic field to a normal magnetic field after the plasma ignition.

According to another embodiment of the present invention, there is provided a microwave ion source starting method including applying an initial magnetic field for plasma ignition to a plasma chamber of a microwave ion source, and changing the initial magnetic field to a normal magnetic field after the plasma ignition.

### BRIEF DESCRIPTION OF THE DRAWINGS

FIG. 1 is a schematic diagram showing a configuration of a microwave ion source according to an embodiment of the present invention.

FIG. 2 is a diagram showing an example of a normal magnetic field according to an embodiment of the present invention.

FIG. 3 is a diagram showing an example of an initial magnetic field according to an embodiment of the present invention.

FIG. 4 is a flowchart illustrating a method for starting the microwave ion source according to an embodiment of the present invention.

### DETAILED DESCRIPTION

It is desirable to provide a practical method for starting a microwave ion source and a microwave ion source that is controlled by using the starting method.

The initial magnetic field may be set to cause an electron cyclotron resonance in the plasma chamber.

The plasma chamber may have a window that receives a microwave, and anion extraction opening. The initial magnetic field may have a flat magnetic field distribution from the window to the ion extraction opening.

The normal magnetic field may be a magnetic field that is higher than a magnetic field which satisfies an electron cyclotron resonance condition from the window to the ion extraction opening.

The control unit may control the magnetic field generator to initiate the application of the initial magnetic field before the microwave is supplied to the plasma chamber.

Any combination between the above-described components and replacement of the components and expressions of the certain embodiments of the present invention between methods, devices, systems and the like are also effective as an aspect of the present invention.

According to the embodiment of the present invention, a practical method for starting a microwave ion source and a microwave ion source that is controlled by using the starting method can be provided.

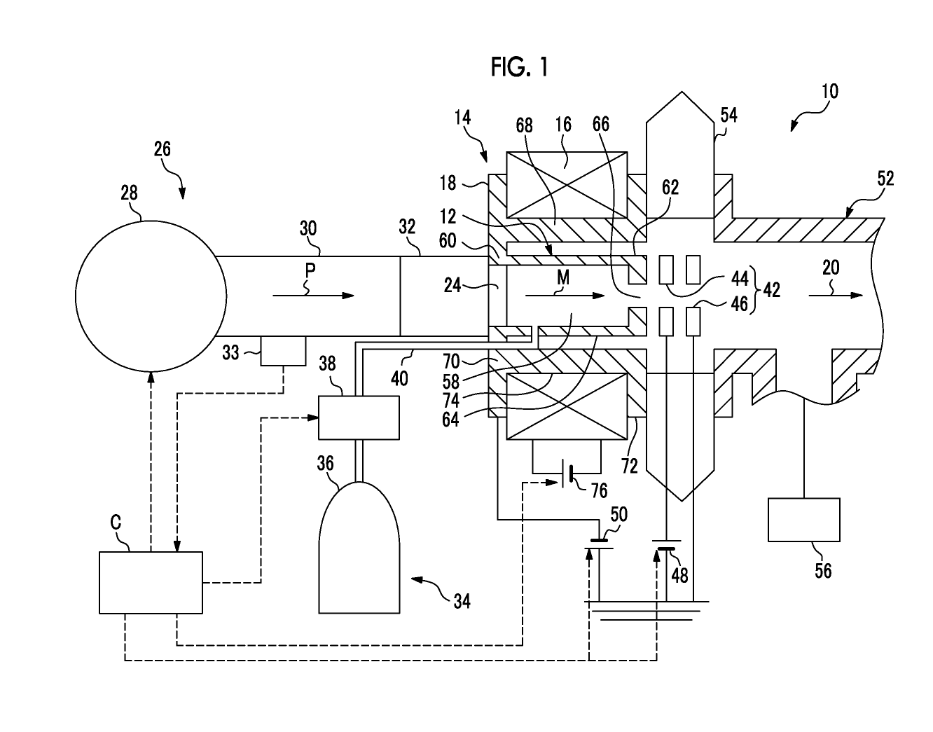

FIG. 1 is a schematic diagram showing a configuration of a microwave ion source 10 according to certain embodiments of the present invention. The microwave ion source 10 is an ion source that inputs microwave power in a direction of a line of magnetic force into a plasma chamber 12 to which a magnetic field satisfying an electron cyclotron resonance (ECR) condition or a higher magnetic field is applied to generate high-density plasma and extract an ion. The microwave ion source 10 is configured to generate plasma of source gas by using an interaction between the magnetic field and microwaves and to extract the ions out of a plasma chamber 12 from the plasma.

As is well known, the strength of the magnetic field satisfying the ECR condition is uniquely determined with respect to the frequency of the microwave which is used. In a case where the microwave frequency is 2.45 GHz, a magnetic field of 87.5 mT (875 gauss) is required. Hereinafter, for convenience, the magnetic field satisfying the ECR condition is referred to as a resonance magnetic field.

The microwave ion source 10 is used in an ion source for an ion implantation device and the like. Examples of the implanted ions include oxygen. Also, the microwave ion source 10 can be used as an ion source for a proton accelerator or an X-ray source as well. The microwave ion source 10 is used mainly as a monovalent ion source.

The microwave ion source 10 includes an ion source main body 14. The ion source main body 14 has the plasma chamber 12, a magnetic field generator 16, and a vacuum vessel 18.

The plasma chamber 12 has a cylindrical shape with both ends. Hereinafter, for convenience, a direction from the one end of the plasma chamber 12 toward the other end may be referred to as an axial direction. Also, a direction that is orthogonal to the axial direction may be referred to as a radial direction, and a direction that surrounds the axial direction may be referred to as a circumferential direction. However, these do not necessarily mean that the plasma chamber 12 is shaped to have rotational symmetry. The plasma chamber 12 has a cylindrical shape in the example that is shown, but the plasma chamber 12 may have any shape if the plasma can be contained appropriately. Also, the axial-direction length of the plasma chamber 12 may be longer or may be shorter than the radial-direction length of an end portion of the plasma chamber 12.

The magnetic field generator 16 is disposed in the plasma chamber 12 so as to apply a magnetic field. The magnetic field generator 16 is configured to generate a magnetic field along a central axis of the plasma chamber 12. The direction of the line of magnetic force is shown by an arrow M in FIG. 1. The magnetic field generator 16 is configured to generate the resonance magnetic field or a higher-strength magnetic field in at least a part on an axis of the plasma chamber 12. Also, the magnetic field generator 16 can generate a magnetic field which is lower than the resonance magnetic field in at least a part on the axis of the plasma chamber 12.

The vacuum vessel 18 is a housing that contains the plasma chamber 12 in a vacuum environment. The vacuum vessel 18 is a structure that holds the magnetic field generator 16. The plasma chamber 12 has a vacuum window 24 therein so as to receive the microwaves. The plasma chamber 12, the magnetic field generator 16, and the vacuum vessel 18 will be described in detail later.

The microwave ion source 10 includes a microwave supply system 26. The microwave supply system 26 is configured to input the microwave power to the plasma chamber 12 through the vacuum window 24. The microwave supply system 26 has a microwave source 28, a waveguide 30, and a matching section 32. The microwave source 28 is, for example, a magnetron. The microwave source 28 outputs a microwave with a frequency of, for example, 2.45 GHz. The waveguide 30 is a microwave circuit that transfers the microwaves which are output by the microwave source 28 to the plasma chamber 12. One end of the waveguide 30 is connected to the microwave source 28, and the other end is connected to the vacuum window 24 via the matching section 32. The matching section 32 is disposed to match the microwaves.

In this manner, the microwaves are introduced from the microwave supply system 26 to the plasma chamber 12 through the vacuum window 24. The microwaves that are introduced propagate in the plasma chamber 12 toward the end portion of the plasma chamber 12 facing the vacuum window 24. A direction in which the microwaves propagate is shown by an arrow P in FIG. 1. The microwave propagation direction P is identical to a direction of a line of magnetic force M by the magnetic field generator 16. As such, the microwave propagation direction P is identical to the axial direction of the plasma chamber 12.

Also, the microwave supply system 26 has a microwave detector 33 that is disposed in the waveguide 30. The microwave detector 33 has a directional coupler that monitors, for example, incident power toward the plasma chamber 12 and reflected power from the plasma chamber 12. The microwave detector 33 is configured to output a measurement result to a control device C.

The microwave ion source 10 includes a gas supply system 34. The gas supply system 34 is configured to supply the source gas of the plasma to the plasma chamber 12. The gas supply system 34 has a gas cylinder 36 that is a gas source and a gas flow rate controller 38. The source gas is, for example, argon gas. The source gas may contain a component that contains impurities for ion implantation. A tip of gas piping 40 of the gas supply system 34 is connected to the plasma chamber 12 through the vacuum vessel 18. The gas piping 40 is connected to, for example, a side wall 64 of the plasma chamber 12. The gas flow rate controller 38 has an on-off valve that connects or blocks the gas cylinder 36 to or from the plasma chamber 12 or a flow rate control valve that adjusts a gas flow rate from the gas cylinder 36 toward the plasma chamber 12. In this manner, the source gas is supplied at a controlled flow rate from the gas cylinder 36 toward the plasma chamber 12.

The ion source main body 14 has an extraction electrode system 42. The extraction electrode system 42 is configured to extract the ions from the plasma through an ion extraction opening 66 of the plasma chamber 12. The extraction electrode system 42 has a first electrode 44 and a second electrode 46. The first electrode 44 is disposed between the plasma chamber 12 and the second electrode 46. A terminal end portion 62 that has the ion extraction opening 66 and the first electrode 44 are arranged apart from each other, and the first electrode 44 and the second electrode 46 are arranged apart from each other. Each of the first electrode 44 and the second electrode 46 is formed into, for example, an annular shape, and has an opening portion in a central portion so as to pass the ions extracted from the plasma chamber 12.

The first electrode 44 is disposed to extract a cation from the plasma and inhibit returning of an electron from a beam line 52 toward the plasma chamber 12. Accordingly, a negative high voltage is applied to the first electrode 44. A first extraction power supply 48 is disposed so as to apply the negative high voltage to the first electrode 44. The second electrode 46 is grounded. Also, a positive high voltage is applied to the vacuum vessel 18. A second extraction power supply 50 is disposed so as to apply the positive high voltage to the vacuum vessel 18. An absolute value of the positive high voltage that is applied to the vacuum vessel 18 is larger than an absolute value of the negative high voltage that is applied to the first electrode 44. In this manner, a cationic ion beam 20 is extracted from the plasma chamber 12. A direction in which the ion beam 20 is extracted from the plasma chamber 12 is identical to the microwave propagation direction P.

The beam line 52 is disposed in the microwave ion source 10 so as to transport the ion beam 20 that is extracted by the extraction electrode system 42. The beam line 52 is connected to the ion source main body 14 on the side opposite to the microwave supply system 26. The beam line 52 is a vacuum vessel that communicates with the vacuum vessel 18. The beam line 52 is insulated against the vacuum vessel 18 of the ion source main body 14 and is mounted on the vacuum vessel 18. Accordingly, a busing 54 is disposed between the beam line 52 and the vacuum vessel 18.

The busing 54 maintains a withstand voltage between the vacuum vessel 18 and a ground side while maintaining a vacuum in the beam line 52 and the vacuum vessel 18. The busing 54 is formed from an insulating material. The busing 54 has an annular shape and surrounds the extraction electrode system 42. The busing 54 is mounted to be pinched between a mounting flange of a vacuum vessel of each of the beam line 52 and the ion source main body 14.

A vacuum exhaust system 56 is disposed so as to provide the vacuum vessel 18 and the plasma chamber 12 with a vacuum environment. In the example that is shown, the vacuum exhaust system 56 is disposed in the beam line 52. The beam line 52 communicates with the vacuum vessel 18 and the plasma chamber 12, and thus the vacuum exhaust system 56 can evacuate the vacuum vessel 18 and the plasma chamber 12. The vacuum exhaust system 56 has a high-vacuum pump, examples of which include a cryopump and a turbo-molecular pump.

The microwave ion source 10 may include the control device C so as to control an output of the ion beam 20. The control device C controls each component of the microwave ion source 10, controls the plasma generated in the plasma chamber 12, and thereby controls the output of the ion beam 20. The control device C is configured to control operations of the microwave supply system 26, the gas supply system 34, a coil power supply 76, and the like. The control device C may control the output of the ion beam 20 by adjusting at least one of the flow rate of the source gas, the microwave power, magnetic field strength, and the like.

The plasma chamber 12 is configured to generate and maintain the plasma in an internal space thereof. Hereinafter the internal space of the plasma chamber 12 is referred to as a plasma containing space 58.

The plasma chamber 12 has a starting end portion 60, the terminal end portion 62, and the side wall 64. The starting end portion 60 and the terminal end portion 62 face each other across the plasma containing space 58. The side wall 64 surrounds the plasma containing space 58 and connects the starting end portion 60 with the terminal end portion 62. In this manner, the plasma containing space 58 is defined in the vacuum vessel 18 by the starting end portion 60, the terminal end portion 62, and the side wall 64. In a case where the plasma chamber 12 has a cylindrical shape, the starting end portion 60 and the terminal end portion 62 are disk-shaped and the side wall 64 is a cylinder, and an end of the side wall 64 is fixed to outer circumferential portions of the starting end portion 60 and the terminal end portion 62.

The starting end portion 60 has the vacuum window 24. The vacuum window 24 may account for the entirety of the starting end portion 60 and may be formed in a part (for example, a central portion) of the starting end portion 60. One side of the vacuum window 24 faces the plasma containing space 58, and the other side of the vacuum window 24 is directed toward the microwave supply system 26. The vacuum window 24 seals an inner portion of the plasma chamber 12 in vacuum. The microwave propagation direction P is vertical to the vacuum window 24. The vacuum window 24 is formed from a dielectric (for example, alumina or boron nitride) with a low dielectric loss. The other portion of the plasma chamber 12 excluding the vacuum window 24 is formed from a non-magnetic metal material or the like.

The one or more ion extraction openings 66 are formed in the terminal end portion 62. The ion extraction opening 66 is formed at a position facing the vacuum window 24 across the plasma containing space 58. In other words, the vacuum window 24, the plasma containing space 58, and the ion extraction opening 66 are arranged along the axial direction of the plasma chamber 12.

The vacuum vessel 18 has a dual-tube structure where the plasma chamber 12 is integrally formed. In other words, the plasma chamber 12 is an inner cylinder of the vacuum vessel 18, and an outer casing 68 that contains the plasma chamber 12 is disposed outside thereof. The outer casing 68 may have a cylindrical shape that is coaxial with the plasma chamber 12. A gap is present between the outer casing 68 and the side wall 64 of the plasma chamber 12, and a tip portion of the gas piping 40 of the gas supply system 34 described above moves into the gap and is mounted on the side wall 64. The vacuum vessel 18 is formed from a non-magnetic metal material or the like.

The vacuum vessel 18 may be integrally formed with the plasma chamber 12. The vacuum vessel 18 and the plasma chamber 12 may be separate bodies and divisible. Also, the vacuum vessel 18 itself may form the plasma chamber 12. In a case where the vacuum vessel 18 also serves as the plasma chamber 12 in this manner, an endplate that has the ion extraction opening 66 may be mounted on a beam line 52 side of the outer casing 68.

One end of the vacuum vessel 18 is blocked by an endplate 70, and the other end is open toward the beam line 52. The starting end portion 60 of the plasma chamber 12 is formed in a central portion of the end plate 70. An outer circumferential portion of the end plate 70 extends in the radial direction to outside the outer casing 68. Amounting flange 72 for the busing 54 is disposed in an end portion of the vacuum vessel 18 on the beam line 52 side. The mounting flange 72 extends outside in the radial direction from the outer casing 68. The vacuum vessel 18 and the plasma chamber 12 have the same axial-direction length and the mounting flange 72 and the terminal end portion 62 of the plasma chamber 12 have axial-direction positions matching each other. The vacuum vessel 18 and the plasma chamber 12 may have different axial-direction lengths.

A magnet holding section 74 is formed in the vacuum vessel 18 so as to hold the magnetic field generator 16. The magnet holding section 74 is formed on, for example, an outer surface of the outer casing 68 of the vacuum vessel 18. In this embodiment, the magnetic field generator 16 is disposed outside the vacuum vessel 18 (that is, in the atmosphere). The magnetic field generator 16 is placed in such a manner as to surround the vacuum vessel 18. However, in another example, the vacuum vessel 18 may have the magnet holding section 74 which holds the magnetic field generator 16 in the vacuum vessel 18 (that is, in vacuum). Even in this case, the same effect as in this example can be achieved. In this manner, the magnetic field generator 16 is placed in such a manner as to surround the plasma containing space 58.

The magnetic field generator 16 has a coil that is configured to generate a magnetic field directed to the axial direction of the plasma chamber 12. In this example, the plasma chamber 12 and the vacuum vessel 18 have a cylindrical shape and the coil is formed into an annular shape, and a conductive wire is wound in a circumferential direction of the plasma chamber 12. The magnetic field generator 16 has the coil power supply 76 that passes an electric current to the coil. The magnetic field generator 16 may have a plurality of coils that are arranged along the axial direction of the plasma chamber 12 instead of having one coil as is shown.

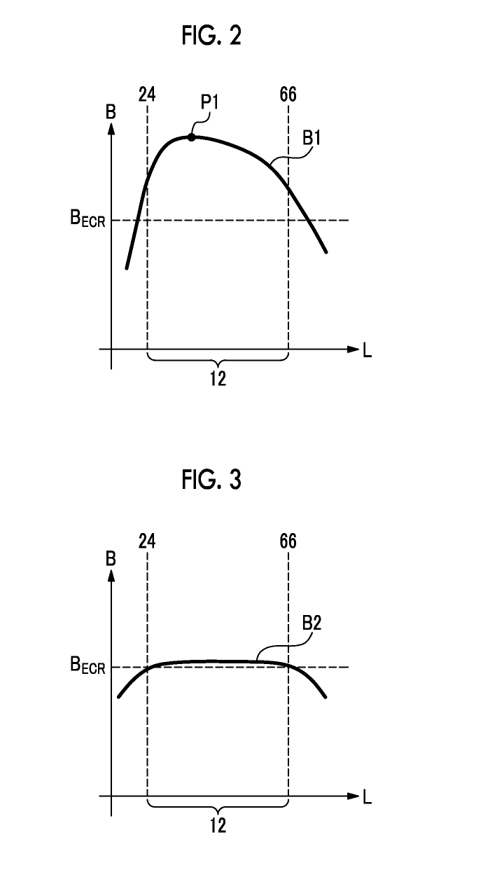

FIG. 2 is a diagram showing an example of a normal magnetic field B1 according to certain embodiments of the present invention. The vertical axis in FIG. 2 represents axial flux density B on the central axis of the plasma chamber 12, and the horizontal axis represents an axial-direction position of the plasma chamber 12. Accordingly, FIG. 2 shows axial-direction magnetic field distribution of the normal magnetic field B1. In the horizontal axis in FIG. 2, an axial-direction position of the vacuum window 24 that is one end of the plasma chamber 12 and an axial-direction position of the ion extraction opening 66 that is the other end of the plasma chamber 12 are shown with respective signs. A resonance magnetic field B_{ECR} is shown in FIG. 2. The same notation is applied also to the following FIG. 3.

The normal magnetic field B1 is a magnetic field that is suitable for maintaining the high-density plasma. The control device C controls the magnetic field generator 16 so that the normal magnetic field B1 is applied to the plasma chamber 12 during a normal operation of the microwave ion source 10.

As is shown, in the plasma chamber 12, the normal magnetic field B1 has a unimodal magnetic field distribution that exceeds the resonance magnetic field B_{ECR} from the vacuum window 24 to the ion extraction opening 66 and has a peak P1 in the plasma chamber 12. An axial-direction position of the peak P1 is closer to the vacuum window 24 than to the ion extraction opening 66. The magnetic field strength decreases monotonically from the peak P1 to the vacuum window 24, and decreases monotonically from the peak P1 to the ion extraction opening 66. As such, a decreasing gradient from the peak P1 to the vacuum window 24 is larger than a decreasing gradient from the peak P1 to the ion extraction opening 66. The magnetic field strength in the vacuum window 24 may be equal to or somewhat larger than the magnetic field strength in the ion extraction opening 66. Also, the magnetic field distribution is flat in the vicinity of the peak P1 of the normal magnetic field B1. Strength of the peak P1 is within a range of, for example, approximately 1.3 times to approximately 1.6 times the resonance magnetic field B_{ECR}.

FIG. 3 is a diagram showing an example of an initial magnetic field B2 according to certain embodiments of the present invention. The initial magnetic field B2 is a magnetic field that is suitable for ignition of the plasma in the plasma chamber 12. The initial magnetic field B2 is set to cause an electron cyclotron resonance in the plasma chamber 12. Accordingly, the initial magnetic field B2 matches the resonance magnetic field B_{ECR} in at least a part of the plasma chamber 12 or has a magnetic field in the vicinity thereof. The control device C controls the magnetic field generator 16 so that the initial magnetic field B2 is applied to the plasma chamber 12 during a starting operation of the microwave ion source 10.

As is shown, the initial magnetic field B2 has a flat magnetic field distribution from the vacuum window 24 to the ion extraction opening 66. Strength of the initial magnetic field B2 in the plasma chamber 12 is almost equal to the resonance magnetic field B_{ECR} and is, for example, 95% to 105% of the resonance magnetic field B_{ECR}, preferably 97% to 103% thereof and further preferably 99% to 101% thereof. Accordingly, the initial magnetic field B2 may be a magnetic field that is somewhat lower than the resonance magnetic field B_{ECR} in at least a part in the plasma chamber 12. The initial magnetic field B2 that is shown is a magnetic field which matches the resonance magnetic field B_{ECR} in the vacuum window 24 and the ion extraction opening 66 and is higher than the resonance magnetic field B_{ECR} from the vacuum window 24 to the ion extraction opening 66. In this manner, the initial magnetic field B2 has a magnetic field distribution more reduced than the normal magnetic field B1 in the plasma chamber 12.

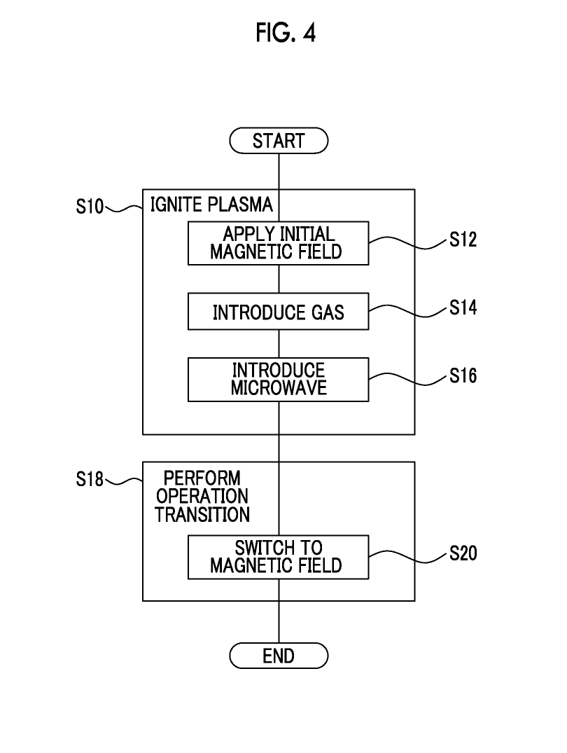

FIG. 4 is a flowchart illustrating a method for starting the microwave ion source 10 according to the certain embodiments of the present invention. The method includes an ignition process (S10) to ignite the plasma in the plasma chamber 12 of the microwave ion source 10, and a transition process (S20) to move to the normal operation of the microwave ion source 10 after the plasma ignition. The control device C implements the method by controlling the operations of the components of the microwave ion source 10 such as the magnetic field generator 16, the microwave supply system 26, and the gas supply system 34.

The ignition process (S10) has applying the initial magnetic field B2 to the plasma chamber 12 of the microwave ion source 10 for the plasma ignition (S12), introducing the gas from the gas supply system 34 to the plasma chamber 12 (S14), and introducing the microwaves from the microwave supply system 26 to the plasma chamber 12 (S16).

The operation of the microwave ion source 10 is initiated under the control by the control device C (or through an operation by an operator). The electric current is supplied from the coil power supply 76 to the coil of the magnetic field generator 16, and the initial magnetic field B2 is generated in the plasma chamber 12. The source gas is supplied from the gas supply system 34 to the plasma chamber 12. The microwave is introduced from the microwave supply system 26 to the plasma chamber 12 through the vacuum window 24. The microwave is incident on the plasma chamber 12 along the axial direction.

In this manner, the control device C controls the magnetic field generator 16 in such a manner that the application of the initial magnetic field B2 is initiated before the supply of the microwave to the plasma chamber 12. Also, the control device C introduces the source gas to the plasma chamber 12 before the supply of the microwave to the plasma chamber 12. Accordingly, the microwave is introduced to the plasma chamber 12 in a state where the initial magnetic field B2 is applied to the plasma chamber 12 and the source gas is supplied. The electron cyclotron resonance is generated by an effect of the microwave and the initial magnetic field B2 and the plasma is generated in the plasma chamber 12.

The transition process (S18) has changing the initial magnetic field B2 to the normal magnetic field B1 after the plasma ignition (S20). The control device C controls the magnetic field generator 16 in such a manner that switching is made from the initial magnetic field B2 to the normal magnetic field B1 after, for example, a predetermined period from the initiation of the introduction of the microwave. The predetermined period is a period required for the ignition of the plasma and, for example, less than several seconds. According to this method, the plasma is reliably ignited immediately after the introduction of the microwave, and thus the control device C may switch to the normal magnetic field B1 at the same time as the introduction of the microwave.

The transition process (S18) may have detecting the plasma ignition by using the microwave detector 33. When the plasma is ignited, reflectance of the microwave in the plasma chamber 12 somewhat drops. The drop in reflectance is detected by the microwave detector 33. Accordingly, the control device C may determine whether the plasma is ignited or not based on the measurement result of the microwave detector 33 and, in a case where the ignition is determined, may change the initial magnetic field B2 to the normal magnetic field B1.

In this manner, the microwave ion source 10 moves from a plasma ignition operation to the normal operation. In the normal operation, the ion is extracted from the plasma through the ion extraction opening 66 by the extraction electrode system 42. The extracted ion is supplied to the beam line 52.

In any general starting operation of the microwave ion source 10, the microwave and the source gas are introduced to the plasma chamber 12 in a state where the normal magnetic field B1 is applied. In this case, the ignition of the plasma can be accelerated by temporarily increasing source gas pressure in the plasma chamber 12 to be higher than usual. However, the normal magnetic field B1 is separated from the resonance magnetic field B_{ECR}, and thus the ignition of the plasma may not be ensured in this method. Also, pressure rise in the plasma chamber 12 may impose a load on vacuum measurement equipment (for example, an ionization vacuum gauge) measuring degree of vacuum of the plasma chamber 12.

In contrast, according to this embodiment, the initial magnetic field B2 that has a magnetic field distribution in the vicinity of the ECR condition is applied to the plasma chamber 12 for the plasma ignition. The ECR is an interaction that is generated even when only one charged particle is present in a state where the plasma is not present. Accordingly, the plasma can be ignited with ease and reliability. Also, according to this embodiment, the normal magnetic field B1 that is suitable for the high-density plasma is applied to the plasma chamber 12 after the plasma ignition. In this manner, the ignited plasma can be grown into the high-density plasma.

Also, according to this embodiment, the microwave is introduced to the plasma chamber 12 in a state where the initial magnetic field B2 is applied to the plasma chamber 12 and the source gas is supplied. The magnetic field in the vicinity of the ECR condition has a high microwave reflectance. Accordingly, unnecessary reflection and consumption of the microwave can be suppressed by introducing the microwave in the final stage of the ignition process.

Hereinabove, the present invention has been described based on the certain embodiments. The present invention is not limited to the above-described embodiments but various design changes are possible. It will be well understood by those skilled in the art that various modification examples are possible and such modification examples are also included in the scope of the present invention.

What is claimed is:

1. A microwave ion source comprising:
a plasma chamber;
a magnetic field generator that generates a magnetic field in the plasma chamber; and
a control unit that controls the magnetic field generator to apply an initial magnetic field for plasma ignition to the plasma chamber and change the initial magnetic field to a normal magnetic field after the plasma ignition.

2. The microwave ion source according to claim 1,
wherein the initial magnetic field is set to cause an electron cyclotron resonance in the plasma chamber.

3. The microwave ion source according to claim 2,
wherein the plasma chamber includes:
a window that receives a microwave; and
an ion extraction opening, and
wherein the initial magnetic field has a flat magnetic field distribution from the window to the ion extraction opening.

4. The microwave ion source according to claim 3,
wherein the normal magnetic field is a magnetic field that is higher than a magnetic field which satisfies an electron cyclotron resonance condition from the window to the ion extraction opening.

5. The microwave ion source according to claim 1,
wherein the control unit controls the magnetic field generator to initiate the application of the initial magnetic field before the microwave is supplied to the plasma chamber.

6. A microwave ion source starting method comprising:
applying an initial magnetic field for plasma ignition to a plasma chamber of a microwave ion source; and
changing the initial magnetic field to a normal magnetic field after the plasma ignition.
